(19) United States
(12) Patent Application Publication
(10) Pub. No.: US 2015/0309332 A1
(43) Pub. Date: Oct. 29, 2015

(54) Vision Aid for Manipulating the Retinal Image for Eyes Having Macular Degeneration

(71) Applicant: ILMENAU OPTICS SOLUTIONS GMBH, Ilmenau (DE)

(72) Inventors: Matthias Hillenbrand, Ilmenau (DE); Stefan Sinzinger, Ilmenau (DE); Beate Mitschunas, Ilmenau (DE)

(21) Appl. No.: 14/443,660

(22) PCT Filed: Nov. 26, 2013
(86) PCT No.: PCT/EP2013/074738

§ 371 Date: May 19, 2015

(30) Foreign Application Priority Data
Nov. 28, 2012 (DE) 10 2012 023 478.3

(51) Int. Cl. G02C 7/02; G02C 7/08; G02C 7/14

(52) U.S. Cl. CPC G02C 7/022; G02C 7/14; G02C 7/081; G02C 2202/10

(57) ABSTRACT

A compact, efficient and more patient-friendly device for manipulating, in particular enlarging and/or redirecting and/or distorting or altering, image information passing through an optical system is to be provided with this invention.

The device as per the invention is characterized by a micro-segmentation of the optically active surfaces in which a number of micro-segments (9), (12) and/or (13) that manipulate the image information and micro-segments (14) that do not manipulate the image information are alternately arranged in the form of an array; an individual micro-segment represents a complete optical system.

The invention can be used, in particular, as a vision aid for patients who suffer, as an example, from a partial loss of the field of vision because of macular degeneration.

### CROSS-REFERENCE TO RELATED APPLICATIONS

This application is the U.S. national stage of International Application No. PCT/EP2013/074738 filed on Nov. 26, 2013, and claims the benefit thereof. The international application claims the benefit under 35 USC 119 of German Application No. DE 102012023478.3 filed on Nov. 28, 2012; all applications are incorporated by reference herein in their entirety.

### BACKGROUND

This invention relates to a device for manipulating image information and its use. In particular, the enlargement and/or redirection and/or symmetrical or asymmetrical distortion of image information passing through an optical system is to be defined with the term manipulation below.

A major area of use of the invention involves the therapy of patients suffering from macular degeneration. Macular degeneration (MD) constitutes damage to the retina of a human eye that has not been able to be healed up to now and especially arises in older people (age-related macular degeneration—AMD). The central area of the retina, called the macula, including the fovea, the point of sharpest vision, is especially affected to a strong degree in a typical case. Patients suffering from MD complain about a loss of function of the central field of vision and are frequently no longer in a position to read, to orient themselves in road traffic or to recognize faces. The peripheral areas of the retina are usually still intact, and the possibility consequently exists to redirect the information relevant to the loss of function of the field of vision to the healthy areas of the retina. Since the density of the visual cells drops significantly towards the edge of the field of vision, a combination of redirection and enlargement of the central information is advisable.

A number of publications exists in the prior art that concern themselves with image redirection and/or enlargement of the image information with the help of vision aids. In so doing, a distinction is made between vision aids that only redirect a portion of the field of vision or those that redirect the entire field of vision that can be influenced by the glasses. As an example, possibilities of image redirection for the entire field of vision are described in DE 10 2005 063 238 A1, EP 1 647 853 A1, US 2005/225714 A1 and US 2005/248723 A1 In contrast, solutions for the image redirection that only involve part of the field of vision are provided in EP 1 816 505 A1, GB 2 338 077 A and US 2007/097316 A1.

Whereas the image enlargement involves the entire field of vision in DE 94 00 864 U1, the image enlargement is only presented for a portion of the field of vision in DE 10 2006 028 476 A1.

In addition, solutions are known in the prior art that involve image redirection in combination with image enlargement. As examples, U.S. Pat. No. 4,958,924 A, EP 0 357 848 A1, EP 1 647 853 A1 or US 2007/252948 A1 describes an image redirection in combination with image enlargement for the entire field of vision and DE 102 48 036 A1 describes this for a portion of the field of vision.

Almost all of the known vision aids involve macroscopic solutions in which individual convention optical elements (lenses, prisms and mirrors) are used for image redirection and image enlargement (e.g. the complete field of vision is redirected by a mirror). These macroscopic solutions are usually associated with high weight (lenses and prisms) and installation space. At the same time, there are substantial limitations with regard to the field of vision that is covered, the enlargements that can be achieved and the image redirection that can be achieved. The solutions presented in WO 2005/059630 A2 and EP 1 816 505 A1, in which the image-redirection element can be made up of an array of several equal partial elements, are an exception. Furthermore, distortion-free enlargement or redirection of the image information is strived for in all of these solutions.

Moreover, a device for manufacturing AMD vision aids is presented in general in DE 10 2007 004 364 A1.

The idea of miniaturization of a vision aid that simultaneously enlarges and redirects is known from the publication: M. Hillenbrand, B. Mitschunas, S. Homberg and S. Sinzinger: Novel vision aids for people suffering from Age-Related Macular Degeneration, Proc. DGaO 2012, B28. The ideas presented here are limited, however, to a rigid lens made of plastic into which individual facets are inserted with a refractive front and back surface in each case. These facets are arranged in a planar fashion in one plane, they all have the same shape and they combine an enlarging effect with an image-redirecting effect. The original information is completely replaced by the redirected information in the corresponding field region because the facets border one another without spacings.

### SUMMARY

A compact, efficient and more patient-friendly device for manipulating, in particular enlarging and/or redirecting and/or distorting or altering, image information passing through an optical system is to be provided with this invention.

The device as per the invention is characterized by a micro-segmentation of the optically active surfaces in which a number of micro-segments (9), (12) and/or (13) that manipulate the image information and micro-segments (14) that do not manipulate the image information are alternately arranged in the form of an array; an individual micro-segment represents a complete optical system.

The invention can be used, in particular, as a vision aid for patients who suffer, as an example, from a partial loss of the field of vision because of macular degeneration.

### DETAILED DESCRIPTION

The object of this invention is to therefore overcome the drawbacks from the prior art and provide a compact, efficient and more patient-friendly device for manipulating, in particular enlarging and/or redirecting and/or distorting or altering, image information passing through an optical system.

This problem is solved as per the invention with the features of the first claim. Further preferred embodiments of the solution as per the invention are specified in the subordinate claims.

Details and advantages of the invention can be found in the following description section in which the invention is explained in more detail with reference to the drawings that are included.

### BRIEF DESCRIPTION OF THE DRAWINGS

The drawings show the following:

FIG. 1—shows a first example of the device as per the invention

FIG. 2—shows there examples of the micro-segmented optical elements

FIG. 3—shows a second example of the device as per the invention

### DETAILED DESCRIPTION OF THE PREFERRED EMBODIMENTS

A device for manipulating image information is presented with this invention that can be used, in particular, as a vision aid for patients who suffer from a partial loss of the field of vision because of macular degeneration, for instance. It can also be used by healthy people, though, who would like to perceive image information in an enlarged and/or offset and/or distorted fashion. A prerequisite for the use of the invention is that area of the retina are still functional. Depending on the embodiment and application area, the device as per the invention permits an enlargement and/or redirection and/or distortion or alteration of the image information.

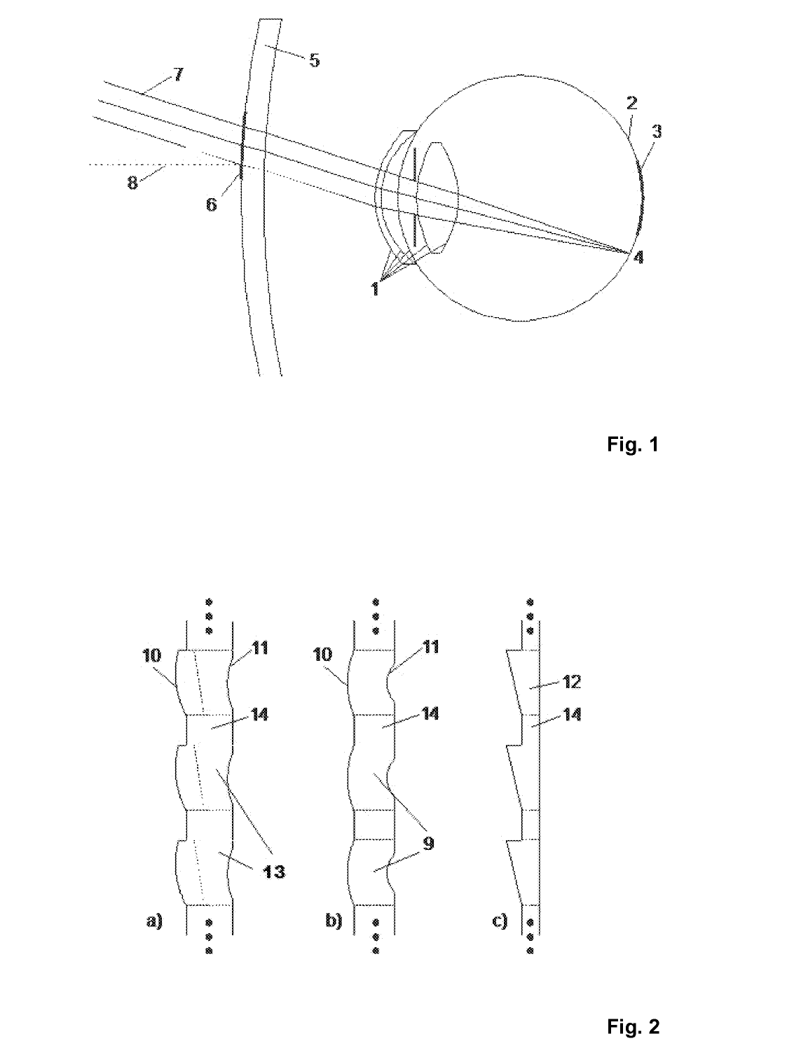

As shown in FIG. 1, the device as per the invention is especially characterized by a micro-segmentation of the optically effective surfaces; an individual micro-segment represents a complete optical system in each case. An optical system is understood below to mean a lens, a prism, a screen or a mirror or a combination of these elements. A micro-segmented film (6) applied to a normal lens (5) provides for simultaneous image redirection and image enlargement. The redirected and enlarged partial image (8) and the non-redirected and non-enlarged partial image (7) are superimposed at the image point (4) of the retina. The brightness of these two partial images can be influenced by the characteristics and arrangement of the micro-segments on the film. Other defective vision issues of the patient can be corrected with the combination of supplemental micro-segmented film with a normal vision aid.

Three different examples of the micro-segmented optical elements (6) are shown in FIG. 2. As per the invention, it is alternately made up of individual micro-segments (9), (12) and (13) that manipulate the image information and micro-segments (14) arranged in arrays that do not manipulate the image information. The term array is intended to designate the arrangement of micro-segments with the same or different sizes and shapes with the same or a variable spacing below.

Various embodiments are possible for the micro-segments (9), (12) and (13) manipulating image information, which each represents a complete optical system in and of itself: variants enlarging, redirecting or distorting image information or combined variants. In FIGS. 2a and 2b, the two facets (10) and (11) represent the outer surfaces of a miniaturized Galileo telescope that enlarges the image information. The wedge element (12) realizes image redirection (image offset and/or image distortion) in FIGS. 2a and 2c. The components (14) that do not manipulate the image information shown in FIGS. 2a, 2b and 2c are designed to be a transparent land as per the invention, and they generate a second partial image. The brightness of the partial images can be influenced by the area ratio between the components that manipulate image information and those that do not manipulate image information.

The micro-segmented optical element (6) is preferably designed to be a film that can be applied to normal glasses. The individual micro-segments can be so small that they are not perceived by the human eye. As a preference, the largest planar extension of the micro-segments is in the range of 0.1 mm to 10 mm, with an especial preference between 0.25 mm and 4 mm. As a very special preference, the extension on the front side is approximately 1.2 mm and the extension on the back side of the micro-segmented element is 0.6 mm. The individual micro-segments can either all have the same shape or can also have a shape that varies over the field (array). In addition, the area ratio between the portions contributing to an image redirection, image distortion and/or image enlargement and areas that do not optically enlarge, distort or redirect the image can be adjusted as desired. This enables the use of two partial images whose relative brightness is influenced by this area ratio: The first partial image represents the original object information that is assigned to this field area, whereas the second partial image contains the redirected, distorted and/or enlarged object information. Either only the normal object information or only the manipulated object information is visible in the extreme variants. The partial-image generation can be further optimized by using absorptive partial surfaces, e.g. for the suppression of stray light.

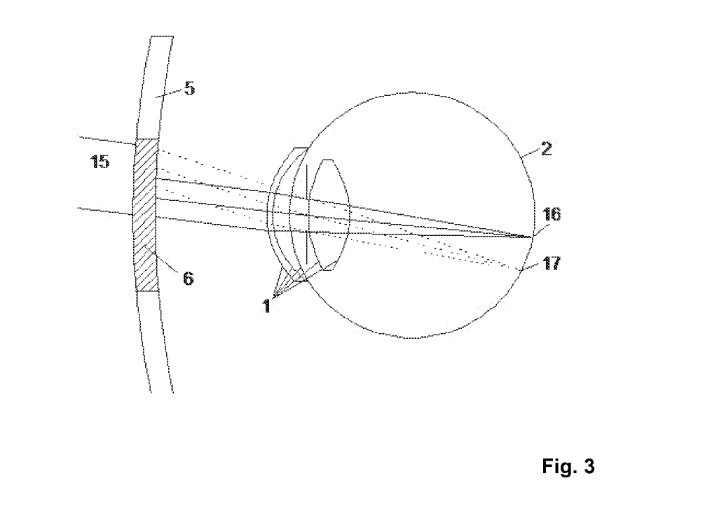

As shown in FIG. 3, a further embodiment of the invention is a device for manipulating image information that does not offer a redirecting or distorting effect, but instead only an enlarging effect over a portion of the field of vision or over the entire field of vision that can be influenced by the vision aid. The enlargement can be arranged to be a function of the field angle via a locally variable form of the micro-segments. The micro-segmented optical element (6) is designed in such a way here that a light bundle (15) coming from an object point will generate two partial images on the retina (3): A non-enlarged partial image (16) and an enlarged partial image (17). The brightness of these partial images is likewise influenced by the structure of the micro-segments. It is possible, as an example, for the center of the field of vision to completely block out the partial image (16) while a continuous transition of brightness to the outer areas of the lens that are not micro-segmented is realized at the edge of the micro-segmented area.

The term enlargement is defined in a general way here, and it also includes an effective reduction of the image information, e.g. to expand the field of vision. Special embodiments of the device as per the invention are therefore also suitable for people who still have an intact macula, for instance, but the peripheral area of the retina is damaged.

The device as per the invention includes various embodiments. They involve both designs that can be used separately, used like a normal pair of glasses, and supplemental elements that are worn in addition to a normal pair of glasses and that can be both in front of and behind normal vision aids. These supplemental elements can have both a rigid and a flexible form. A special embodiment in accordance with the invention is a flexible single-layer or multi-layer film that is applied to the front or rear surface of a pair of glasses. In a preferred embodiment, the flexible single-layer or multi-layer film is merely applied to a partial surface of the lenses of a pair of glasses. The micro-segmented optical element is made of PMMA (for glasses-type elements) as an injection-molded element, for instance, or is manufactured by forming it, for example by embossing a film.

In all of the versions, the micro-segmented optical element can have both a planar form and a curved form. Furthermore, it can be fastened in a self-adhesive form or with auxiliary means to a carrier structure.

Moreover, the invention distinguishes itself by the fact that the individual vision defect of a patient can also be simultaneously corrected in addition to the image redirection, the image distortion and the image enlargement. Additionally, a possibility exists to generate an arbitrary number of partial images and to thus simultaneously redirect, as an example, the central image information upwards and downwards.

When the design is realized in the form of an element supplemental to a further vision aid, the visual defect can be corrected by an individually adapted pair of glasses, for instance, that is simultaneously the carrier structure for the supplemental elements.

The device as per the invention can be made of the most diverse materials. As an example, glass and plastic are conceivable and they can have both a homogeneous and a non-homogeneous material structure. The optical effect of the device can be based on various principles such as reflection, refraction and diffraction, as well as on the effects of a non-homogeneous material structure. Further, the possibility exists to correct or to minimize chromatic aberration via the combination of various materials and optical operating principles. In addition, a device as per the invention can have various areas for distant and close-up vision. For a more pleasant visual experience of the wearer of the vision aid, it can also be combined with color filtering. The possibility exists, as an example, to attenuate light components with a short wavelength. Moreover, the vision aid can be realized in the form of an optical system with a variable working area and/or an optical effect that can be changed.

### LIST OF REFERENCE NUMERALS

1—Model eye

2—Retina

3—Damaged area of the retina

4—Image point on the retina

5—Carrier structure (lens)

6—Micro-segmented optical element

7—Unmodified bundle of rays assigned to image point 4

8—Modified bundle of rays assigned to image point 4

9—Enlarging micro-segment

10—Front facet of the enlarging micro-segment

11—Rear facet of the enlarging micro-segment

12—Redirecting micro-segment

13—Combined micro-segment

14—Micro-segment that does not manipulate the image information

15—Bundle of rays coming from an object

16—Image point without enlargement

17—Image point with enlargement

1. Device for manipulating image information passing through an optical system, characterized in that it comprises at least one micro-segmented optical element (6) having a number of micro-segments (9), (12) and/or (13) that manipulate the image information and that are alternately arranged in the form of an array with micro-segments (14) that do not manipulate image information.

2. Device according to claim 1, characterized in that the micro-segments manipulating the image information are redirecting (12), enlarging (9) or a combination (13) of them.

3. Device according to claim 2, characterized in that the redirecting micro-segments (12) are designed in the form of a wedge.

4. Device according to claim 2, characterized in that the enlarging micro-segments (9) are designed in the form of a miniaturized Galileo telescope.

5. Device according to claim 2, characterized in that the combined micro-segments (13) are designed in the form of a miniaturized Galileo telescope with an integrated wedge or in the form of an array of Galileo telescopes with different-sized wedges.

6. Device according to claim 1, characterized in that the micro-segments (14) that do not manipulate the image information are designed to be transparent or reflective and bar-shaped.

7. Device according to one of the claims 1 to 6, characterized in that the micro-segmented optical element (6) is a flexible film.

8. Device according to one of the claims 1 to 7, characterized in that the micro-segmented optical element (6) is self-adhesive.

9. Device according to one of the claims 1 to 8, characterized in that it can be combined with a medical vision aid with or without absorbent surfaces.

10. Device according to one of the claims 1 to 9, characterized in that it is designed in the form of a medical vision aid with a variable action range and/or an optical effect that can be changed.
